(19) United States
(12) Patent Application Publication
(10) Pub. No.: US 2002/0007288 A1
(43) Pub. Date: Jan. 17, 2002

(54) Home medical examination system and home medical examination method thereof

(75) Inventor: Makoto Endou, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/895,392

(22) Filed: Jul. 2, 2001

(30) Foreign Application Priority Data
Jul. 5, 2000 (JP) 2000-203007

(51) Int. Cl. G06F 17/60

(52) U.S. Cl. 705/3

(57) ABSTRACT

In the home medical examination system, a medical center terminal receives home medical examination request information from a user terminal and a doctor creates a medical examination chart through interactive communication with the user terminal based on the home medical examination request information. The medical center terminal transmits medical examination chart information to a pharmacy terminal and the user terminal through the Internet. The pharmacy terminal compounds a medicine based on prescription information in the medical examination chart information from the medical center terminal and prepares medical equipment and delivers them to a sick person. The pharmacy terminal transmits medicine delivery information to the user terminal and the medical center terminal through the Internet.

### BACKGROUND OF THE INVENTION

1. Field of the Invention

The present invention relates to a home medical examination system and a home medical examination method thereof and, more particularly, to a method of making a diagnosis on a disease and giving medical treatment therefor at home.

2. Description of the Related Art

In conventional diagnosis and medical treatment of a disease, a user (sick person) goes to a medical center (hospital) to have a medical examination (diagnosis), carries a doctor's prescription to a pharmacy to receive a medicine and takes the medicine or applies an ointment, thereby realizing medical treatment and care of the disease.

As to costs of the above-described diagnosis and medical treatment of a disease, the health insurance society and the like accept a unilateral demand for medical care expenses from a medical center (hospital) side and the like to pay medical institutions to the medical center.

According to the above-described conventional method of diagnosis and medical treatment of a disease, even when a user (sick person) complains of a symptom of a disease, he or she should go to a medical center (hospital) to have a doctor's medical examination (diagnosis) and in a case where he or she can not move by himself or herself, he or she should call for an ambulance or the like.

In addition, with his or her power of resistance decreasing due to a disease, he or she should go to a medical center (hospital), so that he or she has danger of affection with other diseases or the like in the medical center (hospital).

Moreover, at a diagnosis and medical treatment of a disease, a medical center (hospital) and a pharmacy need a complicated procedure of demanding costs thereof to request the fee from the health insurance society and the like, which procedure takes much time.

Furthermore, the health insurance society and the like make a payment for medical institutions without precisely grasping the contents of a medical examination and the like and fail to timely grasp a health condition of a member of the health insurance society because the contents of the medical examination are not precisely grasped.

### SUMMARY OF THE INVENTION

An object of the present invention is to provide a home medical examination system and a home medical examination method thereof which solve the above-described problems and enable a user to have a doctor's appropriate medical examination (diagnosis) at home and enable a user to be protected from danger of affection with other diseases in a medical center (hospital).

Another object of the present invention is to provide a home medical examination system and a home medical examination method thereof which enable reduction in complication of a procedure of a medical center (hospital) and a pharmacy to demand fees from the health insurance society and the like and enable the health insurance society and the like to precisely grasp the contents of a medical examination etc. to make an appropriate payment for medical institutions, as well as enabling a health condition of a member of the health insurance society to be grasped.

According to one aspect of the invention, a home medical examination system comprises

a user terminal for a client requesting a home medical examination to make a request for a medical examination of a disease,

a medical center terminal for transmitting a medical examination chart created including instructions on a medical examination of a disease made in response to the request for a medical examination of a disease and on emergency measures based on the examination and instructions on a prescription for a medicine and on the use of medical equipment based on the medical examination of a disease to the user terminal and a facility for compounding the medicine, and

a pharmacy terminal for giving instructions on delivery of the medicine compounded at the compounding facility based on the medical examination chart and the medical equipment and sending the instruction result as delivery information to the user terminal and the medical center terminal.

In the preferred construction, the medical center terminal conducts interactive communication with the user terminal to receive image information and voice information of the client requesting a home medical examination from the user terminal in response to a request for a medical examination of a disease from the user terminal.

In another preferred construction, the user terminal includes a camera for receiving input of the image information and a microphone for receiving input of the voice information.

In another preferred construction, the user terminal, the medical center terminal and the pharmacy terminal are connected through a communication network including the Internet.

In another preferred construction, the client requesting a home medical examination makes a request for a medical examination of a disease by accessing the medical center terminal through the user terminal and entering request information into a home medical examination request of a predetermined format prepared in the medical center terminal.

In another preferred construction, the home medical examination system further comprises a health insurance society terminal for receiving the medical examination chart from the medical center terminal and the delivery information from the pharmacy terminal.

In another preferred construction, the user terminal, the medical center terminal, the pharmacy terminal and the health insurance society terminal are connected through a communication network including the Internet, and the health insurance society terminal receives the medical examination chart from the medical center terminal and the delivery information from the pharmacy terminal through the communication network.

In another preferred construction, the health insurance society terminal calculates costs of a medical examination and medical treatment conducted in response to the request for a medical examination of a disease based on the medical examination chart and the delivery information.

According to another aspect of the invention, a home medical examination method comprising the steps of

making a request for a medical examination of a disease through a user terminal,

transmitting a medical examination chart created including instructions on a medical examination of a disease made in response to the request for a medical examination of a disease and on emergency measures based on the examination and instructions on a prescription for a medicine and on the use of medical equipment based on the medical examination of a disease from a medical center terminal to the user terminal and a facility for compounding the medicine, and

giving instructions on delivery of the medicine compounded at the compounding facility based on the medical examination chart and the medical equipment and sending the instruction result as delivery information from a pharmacy terminal to the user terminal and the medical center terminal.

In the preferred construction, the medical center terminal conducts interactive communication with the user terminal to receive image information and voice information of the client requesting a home medical examination from the user terminal in response to a request for a medical examination of a disease from the user terminal.

In another preferred construction, the user terminal, the medical center terminal and the pharmacy terminal are connected through a communication network including the Internet.

In another preferred construction, the client requesting a home medical examination makes a request for a medical examination of a disease by accessing the medical center terminal through the user terminal and entering request information into a home medical examination request of a predetermined format prepared in the medical center terminal.

In another preferred construction, a health insurance society terminal receives the medical examination chart from the medical center terminal and the delivery information from the pharmacy terminal.

In another preferred construction, the user terminal, the medical center terminal, the pharmacy terminal and the health insurance society terminal are connected through a communication network including the Internet, and the health insurance society terminal receives the medical examination chart from the medical center terminal and the delivery information from the pharmacy terminal through the communication network.

In another preferred construction, the health insurance society terminal calculates costs of a medical examination and medical treatment conducted in response to the request for a medical examination of a disease based on the medical examination chart and the delivery information.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a structure of a home medical examination system according to one embodiment of the present invention;

FIG. 2 is a diagram showing a display screen for a home medical examination request for use in the home medical examination system according to the one embodiment of the present invention;

FIG. 3 is a flow chart showing operation of the home medical examination system according to one embodiment of the present invention;

FIG. 4 is a block diagram showing a structure of a home medical examination system according to another embodiment of the present invention;

FIG. 5 is a flow chart showing operation of the home medical examination system according to another embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

First, outlines of the present invention will be described in the following.

In a home medical examination system of the present invention, a client (sick person) requests a medical examination (diagnosis) of a disease from a doctor or a hospital by means of a user terminal through a network, the doctor or the hospital receiving the request informs the client (sick person) of appropriate instructions on a medical examination (diagnosis) of the disease, an emergency measure or the like, makes up a medical examination chart for a prescription of a medicine, medical equipment, etc. and transmits the information to the user terminal and a pharmacy terminal through the network.

In the home medical examination system of the present invention, a pharmacy (pharmacist) compounds a medicine based on a received prescription and transmits information about the compounded medicine to a doctor or a hospital through the Internet, as well as delivering the compounded medicine and medical equipment to a client (sick person).

Client (sick person) is allowed to have a medical examination (diagnosis) of a disease at his or her own home and to engage in recovering from the disease and medical treatment using a medicine compounded based on a prescription made as a result of a medical examination (diagnosis) by a doctor and medical equipment according to conditions.

More specifically, in the home medical examination system of the present invention, a client (sick person) requesting a medical examination (diagnosis) of a disease transmits his or her own condition of a disease using a user terminal to medical center terminals which are a doctor and a hospital through a network.

Upon reception of the request for a medical examination (diagnosis) of the disease at the medical center terminal, the doctor gives appropriate instructions on an examination (diagnosis) of the disease, an emergency measure, etc. to the client (sick person) through interactive communication, makes up a medical examination chart for a prescription of a medicine, medical equipment, etc. and transmits these information to the user terminal and the pharmacy terminal through the network.

Upon reception of the information by the pharmacy terminal, the pharmacy (pharmacist) compounds a medicine based on the prescription and delivers the medicine, the medical equipment and the like to the client (sick person). In addition, the pharmacy transmits delivery information of the compounded medicine, the medical equipment, etc. from the pharmacy terminal to the medical center terminal and the user terminal through the network.

This enables the client (sick person) to engage in recovering from the disease and medical treatment based on the appropriate emergency measure made by the doctor (hospital) and using the medicine and the medical equipment delivered from the pharmacy (pharmacist).

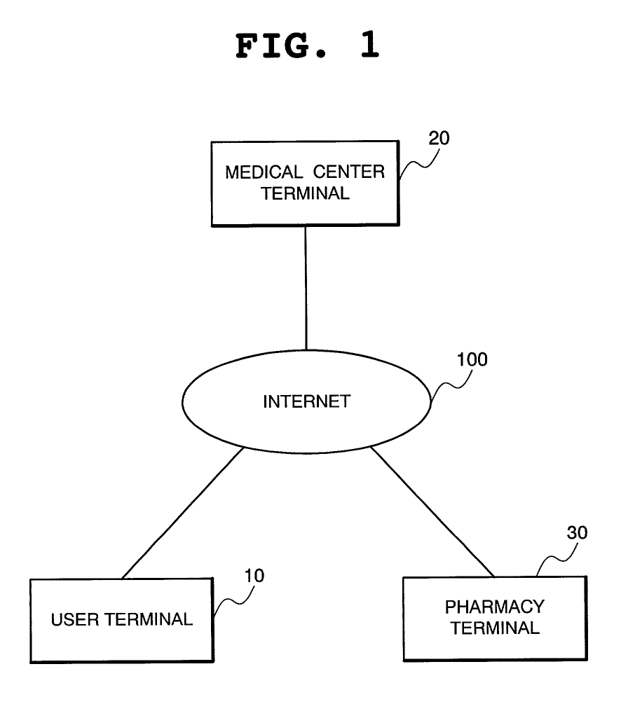

Next, the embodiment of the present invention will be described with reference to the drawings. FIG. 1 is a block diagram showing a structure of a home medical examination system according to one embodiment of the present invention. In FIG. 1, the home medical examination system according to one embodiment of the present invention includes a user terminal 10, a medical center terminal 20, a pharmacy terminal 30 and an Internet 100 which is a communication network for connecting these terminals with each other.

The user terminal 10 is an information processing device such as a personal computer. The user terminal 10 has a function of accessing home medical examination service information provided on the Internet 100 by a medical organization (hospital) and a practicing doctor as the medical center terminals 20 and displaying relevant home medical examination request information on a screen. Home medical examination request information includes personal information such as a name, age, sex, date of birth, residence, etc. of a client who wants a medical examination, information about current medical insurance registration (health insurance certificate No.) and information about current symptoms (current condition of a disease).

The user terminal 10 has a monitoring function using image, an interactive communication (including conversation using words) function and a function of transmitting home medical examination request information to the medical center terminal 20 through the Internet 100. In other words, the user terminal 10 is structured so as to be able to transmit, to the medical center terminal 20, voice information of a sick person input through a microphone not shown and image information of a sick person himself or herself input through a camera not shown [CCD (Charge Coupled Device) camera etc.] as well as home medical examination request information.

The medical center terminal 20 is used by a doctor at a hospital and a practicing doctor who make a medical examination of a sick person and is structured with an information processing device such as a work station server. The medical center terminal 20 receives home medical examination request information sent from the user terminal 10 through operation by a client (sick person) who wants medical treatment of a disease, whereby a doctor makes up a medical examination chart through interactive communication with the client requesting medical treatment (sick person) of the disease at the user terminal 10 based on the home medical examination request information. Medical examination chart includes, for example, doctor's questions • condition observation records, former treatment records, instructions on emergency measures and records of prescriptions of medicines and medical equipment.

The medical center terminal 20 has a function of transmitting medical examination chart information created by a doctor to the pharmacy terminal 30 and the user terminal 10 through the Internet 100.

The pharmacy terminal 30 is used by a pharmacist at a pharmacy and is structured with an information processing device such as a work station server. The pharmacy terminal 30 receives medical examination chart information (doctor's questions • condition observation records, former treatment records, etc. are excluded from medical examination chart information to the pharmacy terminal 30 if possible) sent from the medical center terminal 20 through operation by a doctor at a hospital and a practicing doctor and a pharmacy compounds medicines based on prescription information on the medical examination chart and also prepares medical equipment. The pharmacy delivers the medicine compounded based on the medical examination chart information and medical equipment to the client requesting medical treatment (sick person) by means of a delivery service provider.

The pharmacy terminal 30 has a function of delivering a compounded medicine and medical equipment, as well as transmitting medicine delivery information to the user terminal 10 and the medical center terminal 20 through the Internet 100. Medicine delivery information includes information about, for example, the number and a kind of medicines and medical equipment, dosing and using methods and directions.

The client (sick person) is therefore allowed to engage in recovering from the sickness and medical treatment based on information received by the user terminal 10 from the medical center terminal 20 and the pharmacy terminal 30 through the Internet 100 and medicines and medical equipment delivered from the pharmacy (pharmacist).

Payment of personal medical fee etc. charged on a client (sick person) will be made by paying the fee into a bank account or the like based on a bill from a medical organization, a pharmacy or the like, or by the withdrawal from a personal account at a bank etc.

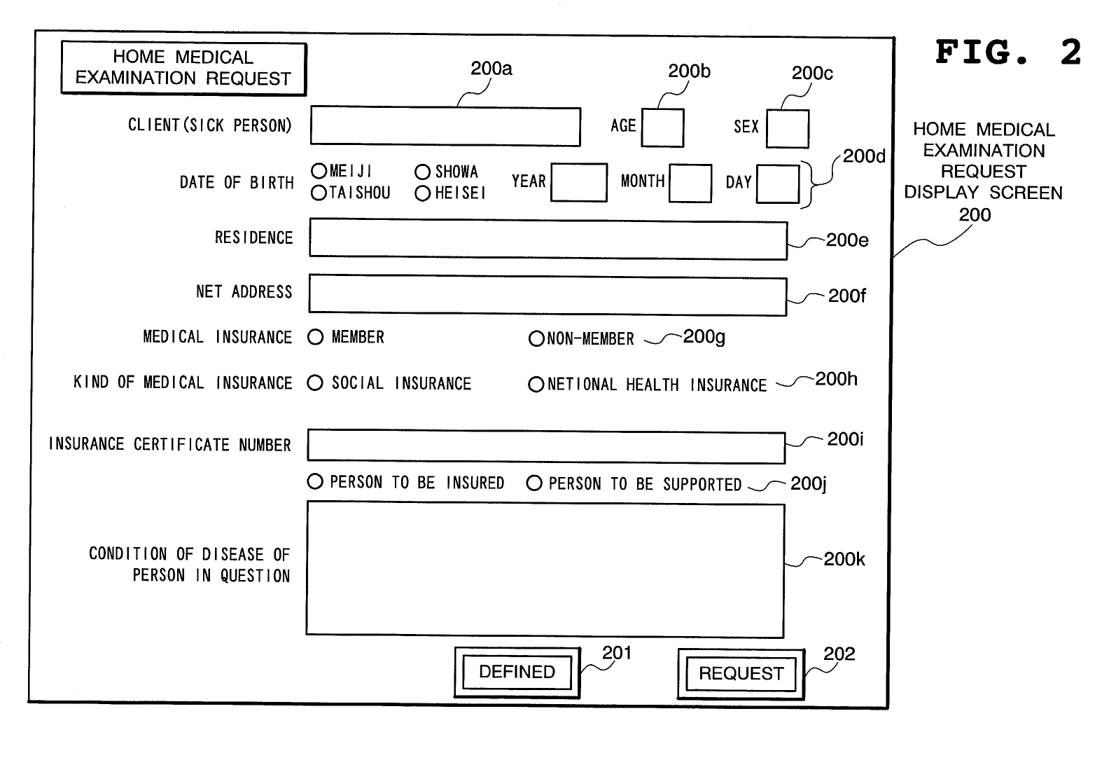

FIG. 2 is a diagram showing a display screen 200 for a home medical examination request displayed on the user terminal 10 of the home medical examination system according to one embodiment of the present invention. In FIG. 2, displayed on the display screen 200 for a home medical examination request are columns to be filled in such as a name column 200a of a client (sick person), an age column 200b, a sex column 200c, a date of birth column 200d, a residence column 200e, a net address column 200f, a column 200g of member/non-member of a medical insurance and a column 200h of a kind of the insurance, an insurance certificate number column 200i, a column 200j for distinction between a person to be insured and a person to be supported, and a column 200k of a condition of a disease of a person in question, to which information can be input.

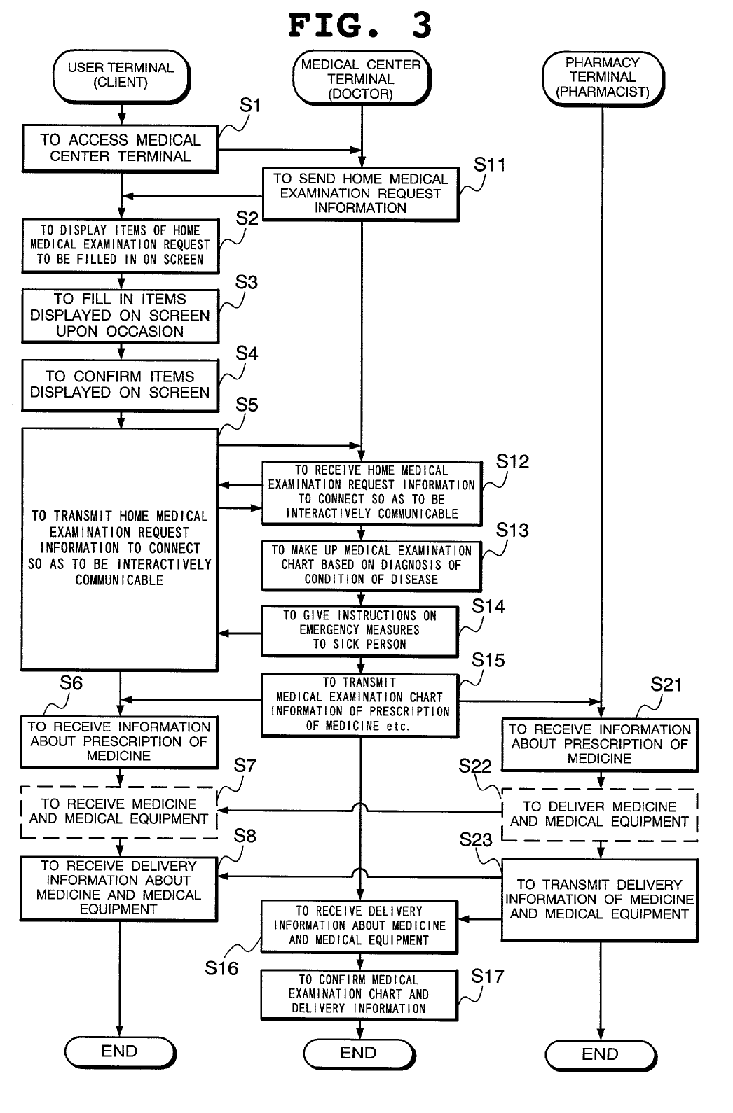

FIG. 3 is a flow chart showing operation of the home medical examination system according to one embodiment of the present invention. With reference to FIGS. 1 to 3, description will be made of operation of the home medical examination system according to one embodiment of the present invention.

One who requests a home medical examination (sick person) accesses a home medical examination service home page opened on the Internet 100 by a medical organization (hospital) and a practicing doctor of the medical center terminals 20 by means of his or her own user terminal 10 (Step S1 of FIG. 3). In response thereto, the medical center terminals 20 of the medical organization (hospital) and the practicing doctor transmit home medical examination request information to the user terminal 10 (Step S11 of FIG. 3).

On the user terminal 10, the display screen 200 for a home medical examination request from the medical center terminal 20 is displayed (see FIG. 2) (Step S2 of FIG. 3). The home medical examination request is displayed such that such information items to be filled in as described above can be entered.

While watching the contents to be entered which are displayed on the screen of the user terminal 10, the client requesting a home medical examination (sick person) upon occasion fills in each item to make a home medical examination request (Step S3 of FIG. 3).

On the display screen 200 for a home medical examination request shown in FIG. 2, the client requesting a home medical examination (sick person) clicks a mouse in the frame to the right of “client (sick person)” displayed on the screen and moves a courser within the frame to enter his or her name through a keyboard. Subsequently, he or she clicks the mouse in the frame to the right of “age” displayed on the screen and moves the courser within the frame to enter his or her age through the keyboard.

In the same manner as described above, required items are entered by means of the mouse and the keyboard as occasion calls such as sex, date of birth, residence, net address, insurance certificate number, condition of a disease and the like. At the places where a date of birth and the medical insurance are to be entered, clicking the mouse in a circle displayed to the left of relevant displayed item characters (e.g. date of birth: ◯ Showa) results in indicating ┌•┘ mark within the circle (which means that the person in question was born in Showa).

After finishing the foregoing entry of a series of home medical examination request information items on the display screen for a home medical examination request shown in FIG. 2, the person in question confirms the entered contents and clicks the mouse at a “defined” frame 201 at the center of the lower part of the screen. Upon clicking the mouse at the “defined” frame, alarm indication is made which show whether minimum items to be filled in (e.g. name and residence of client) are entered or not and whether there is an error in the entered contents. When an alarm is indicated, make another entry at an indicated portion to click the mouse at the “defined” frame again. When no alarm is indicated, OK or the like is displayed (Step S4 of FIG. 3). The home medical examination request information is accumulated at a storage region (not shown) of the user terminal 10.

The home medical examination request information accumulated in the user terminal 10 is transmitted to the medical center terminals 20 of the medical organization (hospital) and the practicing doctor through the Internet 100 by an instruction of the client (sick person) (by clicking the mouse at a “request” frame 202 on the lower right side of the display in FIG. 2) (Step S5 of FIG. 3).

Upon receiving the home medical examination request information, the medical center terminal 20 is connected to the user terminal 10 to be interactively communicable therewith (Steps S12 and S5 of FIG. 3). The medical organization (doctor at the hospital) and the practicing doctor make up medical examination charts based on the received home medical examination request information, interactive communication (including conversation using words) with the client (sick person) at the user terminal 10 and a symptom (condition of a disease) observed by the monitor images (Step S13 of FIG. 3). The doctor at the hospital and the practicing doctor give instructions on emergency measures to the client (sick person), as well as making up the medical examination charts (Step S14 of FIG. 3).

Thereafter, medical examination chart information of a prescription of a medicine, medical equipment, etc. is transmitted from the medical center terminals 20 to the user terminal 10 and the pharmacy terminal 30 through the Internet 100 (S15 of FIG. 3).

The user terminal 10 and the pharmacy terminal 30 receive the information about a prescription of medicines and medical equipment (Steps S6 and S21 of FIG. 3). Based on the information received at the pharmacy terminal 30, a pharmacy (pharmacist) compounds medicines and prepares medical equipment to deliver the same to the client (sick person) by means of a delivery service provider (Step S22 of FIG. 3). In addition to the delivery of the medicine and the medical equipment, the pharmacy (pharmacist) transmits delivery information of the medicine and the medical equipment from the pharmacy terminal 30 to the user terminal 10 and the medical center terminals 20 through the Internet 100 (Step S23 of FIG. 3).

The client (sick person) receives the medicine and the medical equipment delivered from the pharmacy (pharmacist) (Step S7 of FIG. 3) and receives the delivery information about the medicine and the medical equipment from the pharmacy terminal 30 (Step S8 of FIG. 3).

The medical center terminal 20 receives the delivery information about the medicine and the medical equipment sent from the pharmacy terminal 30 (Step S16 of FIG. 3). The doctor who made up the medical examination chart of a prescription for a medicine or the like through the operation of the medical center terminal 20 confirms and collates the delivery information of the medicine and the medical equipment sent from the pharmacy terminal 30 and the contents of his or her own medical examination chart (Step S17 of FIG. 3).

The client (sick person) will engage in recovering from the disease and medical treatment based on the medicine and the medical equipment delivered from the pharmacy and the instruction information from the doctor and the pharmacist. The delivery information of the medicine and the medical equipment from the pharmacy to the client (sick person) may be notified to the client through an electronic mail or the like.

This arrangement eliminates the user's need of going to a medical center (hospital) in a condition of sickness to have a doctor's medical examination (diagnosis) and enables the user to have an appropriate medical examination (diagnosis) of a doctor at home.

This arrangement also prevents a user (sick person) from being exposed to danger of affection with other disease or the like in a medical center (hospital) when he or she goes to the medical center (hospital) with his or her power of resistance decreased.

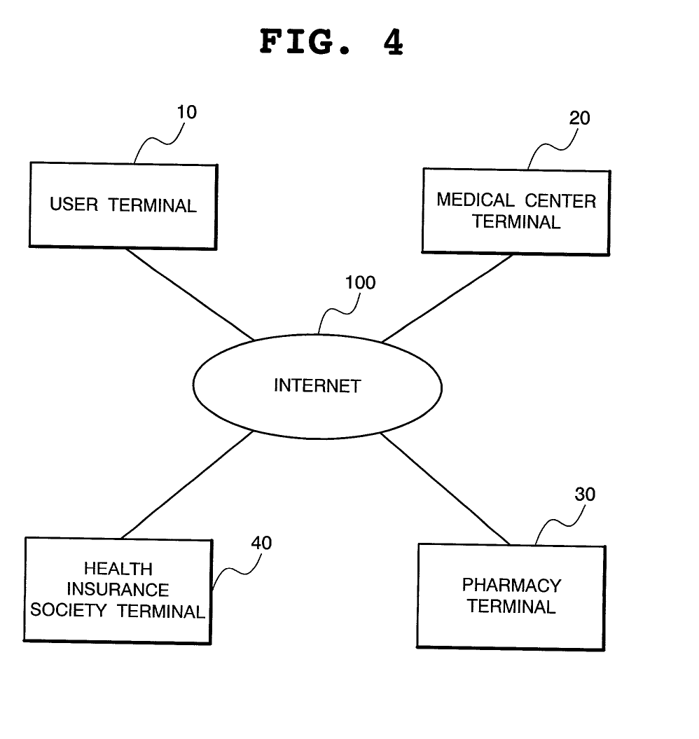

FIG. 4 is a block diagram showing a structure of a home medical examination system according another embodiment of the present invention. In FIG. 4, the home medical examination system according to the embodiment of the present invention has the same structure as that of the home medical examination system according to the one embodiment of the present invention shown in FIG. 1 with the only difference being that a health insurance society terminal 40 is additionally provided to connect to the Internet 100, in which the same or corresponding components are indicated by the same reference numerals. Operation of the corresponding component is the same as that of the one embodiment of the present invention.

A client (sick person) requesting a medical examination (diagnosis) of a disease transmits his or her own condition of a disease using the user terminal 10 to the medical center terminals 20 which are a doctor and a hospital through the Internet 100. The medical center terminal 20 receives the request for a medical examination (diagnosis) of the disease, and the doctor gives appropriate instructions on an examination (diagnosis) of the disease, emergency measures and the like to the client (sick person) through interactive communication, makes up a medical examination chart of a prescription of a medicine, medical equipment, etc. and transmits these information to the user terminal 10, the pharmacy terminal 30 and the health insurance society terminal 40 through the Internet 100.

Upon reception of the information by the pharmacy terminal 30, a pharmacy (pharmacist) compounds the medicine based on the prescription and delivers the medicine and the medical equipment to the client (sick person). In addition, delivery information of the compounded medicine, the medical equipment and the like are transmitted from the pharmacy terminal 30 to the medical center terminal 20, the health insurance society thermal 40 and the user terminal 10 through the Internet 100.

Since the medical examination chart information from the medical center terminal 20 and the delivery information about a medicine, medical equipment and the like from the pharmacy terminal 30 are thus sent to the health insurance society terminal 40, it will be possible for the health insurance society terminal 40 to calculate costs of the medical examination and medical treatment based on these information.

In this case, the medical center terminal 20 has a function of transmitting medical examination chart information to the pharmacy terminal 30, the health insurance society terminal 40 and the user terminal 10 through the Internet 100. The pharmacy terminal 30 has a function of transmitting delivery information about compounded medicines, medical equipment and the like to the health insurance society terminal 40, the medical center terminal 20 and the user terminal 10 through the Internet 100.

The health insurance society terminal 40 is structured with an information processing device such as a work station server and has a function of receiving medical examination chart information created by a doctor based on a home medical examination request and sent from the medical center terminal 20 and delivery information about compounded medicines, medical equipment, etc. sent from the pharmacy terminal 30.

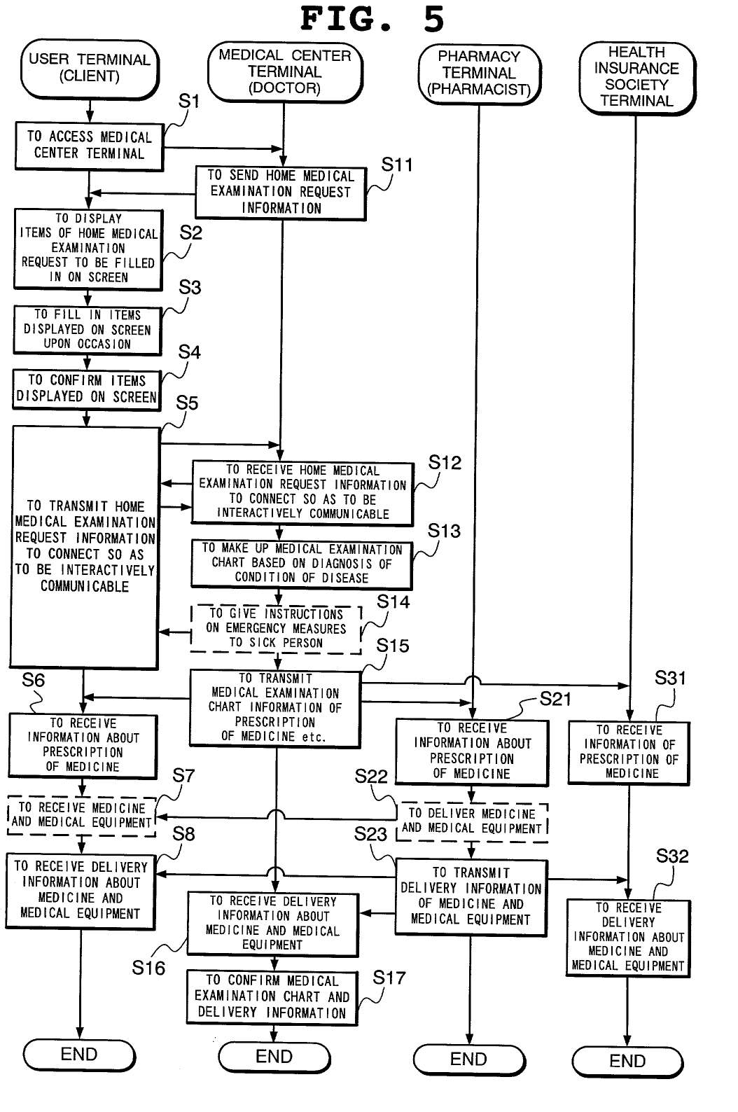

FIG. 5 is a flow chart showing operation of the home medical examination system according to another embodiment of the present invention. With reference to FIGS. 4 and 5, operation of the home medical examination system according to another embodiment of the present invention will be described.

One who requests a home medical examination (sick person) accesses a home medical examination service home page opened on the Internet 100 by a medical organization (hospital) and a practicing doctor of the medical center terminals 20 by means of his or her own user terminal 10 (Step S1 of FIG. 5). In response thereto, the medical center terminals 20 of the medical organization (hospital) and the practicing doctor transmit home medical examination request information to the user terminal 10 (Step S11 of FIG. 5).

On the user terminal 10, items of the home medical examination request information from the medical center terminal 20 to be filled in are displayed on the screen (see FIG. 2) (Step S2 of FIG. 5). While watching the contents to be entered which are displayed on the screen of the user terminal 10, the client requesting a home medical examination (sick person) upon occasion fills in each item to make a home medical examination request (Step S3 of FIG. 5).

After finishing the foregoing entry of a series of home medical examination request information items on the display screen 200 for a home medical examination request shown in FIG. 2, the person in question confirms the entered contents and clicks the mouse at the “defined” frame 201 at the center of the lower part of the screen. Upon clicking the mouse at the “defined” frame 201, alarm indication is made which shows whether minimum items to be filled in (e.g. name and residence of client) are entered or not and whether there is an error in the entered contents. When an alarm is indicated, make another entry at an indicated portion to click the mouse at the “defined” frame 201 again. When no alarm is indicated, OK or the like is displayed (Step S4 of FIG. 5). The home medical examination request information is accumulated at a storage region (not shown) of the user terminal 10.

The home medical examination request information accumulated in the user terminal 10 is transmitted to the medical center terminals 20 of the medical organization (hospital) and the practicing doctor through the Internet 100 upon an instruction of the client (sick person) (by clicking the mouse at the “request” frame 202 on the lower right side of the display in FIG. 2) (Step S5 of FIG. 5).

Upon receiving the home medical examination request information, the medical center terminal 20 is connected to the user terminal 10 so as to be interactively communicable (Steps S12 and S5 of FIG. 5). The medical organization (doctor in the hospital) and the practicing doctor make up medical examination charts based on the received home medical examination request information, interactive communication (including conversation using words) with the client (sick person) at the user terminal 10 and a symptom (condition of a disease) observed by the monitor images (Step S13 of FIG. 5). The doctor in the hospital and the practicing doctor give instructions on emergency measures to the client (sick person), as well as making up the medical examination charts (Step S14 of FIG. 5).

Thereafter, medical examination chart information of a prescription of a medicine, medical equipment, etc. is transmitted from the medical center terminals 20 to the user terminal 10, the pharmacy terminal 30 and the health insurance society 40 through the Internet 100 (S15 of FIG. 5).

The user terminal 10 receives the medical examination chart information about the prescription of the medicine and the medical equipment (Step S6 of FIG. 5). The pharmacy terminal 30 also receives the medical examination chart information about the prescription of the medicine and the medical equipment (Step S21 of FIG. 5). In the same manner, the health insurance society terminal 40 receives the medical examination chart information about the prescription of the medicine and the medical equipment (Step S31 of FIG. 5).

Based on the information received at the pharmacy terminal 30, a pharmacy (pharmacist) compounds medicines and prepares medical equipment to deliver the same to the client (sick person) by means of a delivery service provider (Step S22 of FIG. 5). In addition to the delivery of the medicine and the medical equipment, the pharmacy (pharmacist) transmits delivery information of the medicine and the medical equipment from the pharmacy terminal 30 to the user terminal 10, the medical center terminals 20 and the health insurance society terminal 40 through the Internet 100 (Step S23 of FIG. 5).

The client (sick person) receives the medicine, the medical equipment and the like delivered from the pharmacy (Step S7 of FIG. 5). In addition, the client (sick person) receives the delivery information about the medicine, the medical equipment and the like from the pharmacy terminal 30 by the user terminal 10 (Step S8 of FIG. 5).

The medical center terminal 20 receives the delivery information about the medicine and the medical equipment sent from the pharmacy terminal 30 (Step S16 of FIG. 5). The doctor who made up the medical examination chart of the prescription for the medicine or the like through operation of the medical center terminal 20 confirms and collates the delivery information of the medicine and the medical equipment sent from the pharmacy terminal 30 and the contents of his or her own medical examination chart (Step S17 of FIG. 5).

The health insurance society terminal 40 receives the delivery information of the medicine and the medical equipment sent from the pharmacy terminal 30 (Step S32 of FIG. 5). It is therefore possible for the health insurance society terminal 40 to calculate costs of the medical examination and medical treatment based on these information.

The client (sick person) will engage in recovering from the disease and medical treatment based on the medicine and the medical equipment delivered from the pharmacy and the instruction information from the doctor and the pharmacist. The delivery information of the medicine and the medical equipment from the pharmacy to the client (sick person) may be notified to the client through an electronic mail or the like.

Since this arrangement enables the health insurance society terminal 40 to calculate costs of the medical examination and the medical treatment based on the medical examination chart information such as a prescription of a medicine and medical equipment from the medical center terminal 20 and the delivery information about the medicine and the medical equipment from the pharmacy terminal 30, complication of a procedure of a medical center (hospital) and a pharmacy to demand fees from the health insurance society and the like can be reduced. In addition, the health insurance society or the like is allowed to precisely grasp the contents of a medical examination etc., which enables an appropriate payment of medical institutions, as well as enabling a health condition of a member of the health insurance society to be grasped based on the above-described information.

As described in the foregoing, being provided with a user terminal for making a request for a medical examination of a disease, a medical center terminal responsive to a request for a medical examination of a disease for transmitting a medical examination chart created including a medical examination of the condition of a disease made through the user terminal, instructions on emergency measures based on the examination, and instructions about a prescription of a medicine based on the medical examination of the disease and about how to use medical equipment to the user terminal and a medicine compounding facility, and a pharmacy terminal for giving instructions on the delivery of a medicine compounded at a compounding facility based on a medical examination chart and medical equipment and sending the instruction results as delivery information to the user terminal and the medical center terminal, the home medical examination system of the present invention enables a user to have a doctor's appropriate medical examination (diagnosis) at his or her own home and prevents him or her from running the danger of affection with other diseases in a medical center (hospital).

Being provided with a health insurance society terminal for receiving a medical examination chart from the medical center terminal and delivery information from the pharmacy terminal through a communication network in addition to the above-described terminals, another home medical examination system of the present invention reduces complication of a procedure of a medical center (hospital) and a pharmacy to demand fees from the health insurance society and the like to allow the health insurance society and the like to precisely grasp the contents of a medical examination etc., which enables an appropriate payment of medical institutions, as well as enabling a health condition of a member of the health insurance society to be grasped.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A home medical examination system comprising:
a user terminal for a client requesting a home medical examination to make a request for a medical examination of a disease,
a medical center terminal for transmitting a medical examination chart created including instructions on a medical examination of a disease made in response to said request for a medical examination of a disease and on emergency measures based on the examination and instructions on a prescription for a medicine and on the use of medical equipment based on said medical examination of a disease to said user terminal and a facility for compounding said medicine, and
a pharmacy terminal for giving instructions on delivery of the medicine compounded at said compounding facility based on said medical examination chart and said medical equipment and sending the instruction result as delivery information to said user terminal and said medical center terminal.

2. The home medical examination system according to claim 1, wherein
said medical center terminal conducts interactive communication with said user terminal to receive image information and voice information of said client requesting a home medical examination from said user terminal in response to a request for a medical examination of a disease from said user terminal.

3. The home medical examination system according to claim 2, wherein
said user terminal includes a camera for receiving input of said image information and a microphone for receiving input of said voice information.

4. The home medical examination system according to claim 1, wherein
said user terminal, said medical center terminal and said pharmacy terminal are connected through a communication network including the Internet.

5. The home medical examination system according to claim 4, wherein
said client requesting a home medical examination makes a request for a medical examination of a disease by accessing said medical center terminal through said user terminal and entering request information into a home medical examination request of a predetermined format prepared in said medical center terminal.

6. The home medical examination system according to claim 1, further comprising
a health insurance society terminal for receiving said medical examination chart from said medical center terminal and said delivery information from said pharmacy terminal.

7. The home medical examination system according to claim 1, wherein
said user terminal, said medical center terminal, said pharmacy terminal and said health insurance society terminal are connected through a communication network including the Internet, and
said health insurance society terminal receives
said medical examination chart from said medical center terminal and said delivery information from said pharmacy terminal through said communication network.

8. The home medical examination system according to claim 6, wherein
said health insurance society terminal calculates
costs of a medical examination and medical treatment conducted in response to said request for a medical examination of a disease based on said medical examination chart and said delivery information.

9. A home medical examination method comprising the steps of:
making a request for a medical examination of a disease through a user terminal,
transmitting a medical examination chart created including instructions on a medical examination of a disease made in response to said request for a medical examination of a disease and on emergency measures based on the examination and instructions on a prescription for a medicine and on the use of medical equipment based on said medical examination of a disease from a medical center terminal to said user terminal and a facility for compounding said medicine, and
giving instructions on delivery of the medicine compounded at said compounding facility based on said medical examination chart and said medical equipment and sending the instruction result as delivery information from a pharmacy terminal to said user terminal and said medical center terminal.

10. The home medical examination method according to claim 9, wherein
said medical center terminal conducts interactive communication with said user terminal to receive image information and voice information of said client requesting a home medical examination from said user terminal in response to a request for a medical examination of a disease from said user terminal.

11. The home medical examination method according to claim 9, wherein
said user terminal, said medical center terminal and said pharmacy terminal are connected through a communication network including the Internet.

12. The home medical examination method according to claim 11, wherein
said client requesting a home medical examination makes a request for a medical examination of a disease by accessing said medical center terminal through said user terminal and entering request information into a home medical examination request of a predetermined format prepared in said medical center terminal.

13. The home medical examination method according to claim 9, wherein
a health insurance society terminal receives said medical examination chart from said medical center terminal and said delivery information from said pharmacy terminal.

14. The home medical examination method according to claim 9, wherein
said user terminal, said medical center terminal, said pharmacy terminal and said health insurance society terminal are connected through a communication network including the Internet, and
said health insurance society terminal receives said medical examination chart from said medical center terminal and said delivery information from said pharmacy terminal through said communication network.

15. The home medical examination method according to claim 13, wherein
said health insurance society terminal calculates costs of a medical examination and medical treatment conducted in response to said request for a medical examination of a disease based on said medical examination chart and said delivery information.
